(19) United States
(12) Patent Application Publication
(10) Pub. No.: US 2025/0179343 A1
(43) Pub. Date: Jun. 5, 2025

(54) BIODEGRADABLE SURFACTANT FLUID LOSS CONTROL ADDITIVE

(71) Applicant: Halliburton Energy Services, Inc., Houston, TX (US)

(72) Inventors: Sharad Bhimrao GOTMUKLE, Pune (IN); Nivika Rajendra GUPTA, Pune (IN); Kimberly J. BURROWS-LAWSON, Houston, TX (US)

(73) Assignee: Halliburton Energy Services, Inc., Houston, TX (US)

(21) Appl. No.: 18/526,114

(22) Filed: Dec. 1, 2023

(51) Int. Cl. C09K 8/36; C09K 8/03; C09K 8/26; C09K 8/508

(52) U.S. Cl. CPC C09K 8/36; C09K 8/03; C09K 8/265; C09K 8/5086

(57) ABSTRACT

Invert emulsion treatment fluids can be used in oil and gas operations. A fluid loss control additive (FLCA) is a component of the fluid that can be utilized to control or minimize fluid loss into a subterranean formation. The FLCA can be a biodegradable surfactant of a sorbitan ester. The treatment fluid can include a bridging agent of insoluble particles. The biodegradable surfactant can aid the bridging agent to enter into permeable areas of the subterranean formation and consolidate to reduce or prevent fluid loss.

### TECHNICAL FIELD

Wellbore treatment operations can involve pumping a treatment fluid into a wellbore. The treatment fluid generally includes a liquid as the base fluid. During introduction into the wellbore, some of the base fluid can be lost into a subterranean formation that is penetrated by the wellbore. Improved fluid loss control additives can be used to reduce the amount of base fluid or filtrate that is lost.

### BRIEF DESCRIPTION OF THE FIGURES

The features and advantages of certain embodiments will be more readily appreciated when considered in conjunction with the accompanying FIGURES. The FIGURES are not to be construed as limiting any of the preferred embodiments.

FIG. 1 is a graph showing HTHP fluid loss of 3 different fluids at different testing temperatures according to certain embodiments.

### DETAILED DESCRIPTION

Oil and gas hydrocarbons are naturally occurring in some subterranean formations. In the oil and gas industry, a subterranean formation containing oil and/or gas is referred to as a reservoir. A reservoir can be located under land or offshore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from a reservoir is called a reservoir fluid.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be a slurry, which includes a continuous liquid phase and undissolved solid particles as the dispersed or discontinuous phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term “base fluid” means the solvent of a solution or the continuous phase of a heterogeneous fluid and is the liquid that is in the greatest percentage by volume of a treatment fluid. An emulsion has a continuous phase of water and immiscible liquid oil droplets as the dispersed or discontinuous phase or has a continuous phase of an oil and immiscible liquid water droplets as the dispersed or discontinuous phase. When naming an emulsion type, the first letter is the discontinuous phase. Accordingly, O/W is oil in water and is classified as an “emulsion”; whereas W/O is water in oil and is classified as an “invert emulsion”.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet (30.5 meters) radially of the wellbore. As used herein, “into a subterranean formation” means and includes into any portion of the well, including into the wellbore, into the near-wellbore region via the wellbore, or into the subterranean formation via the wellbore.

A portion of a wellbore can be an open hole or cased hole. In an open-hole wellbore portion, a tubing string can be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include but are not limited to the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

Oil or gas operations can be performed using a treatment fluid. The term “treatment fluid” refers to the specific composition of the fluid as it is being introduced into a well. The word “treatment” in the term “treatment fluid” does not necessarily imply any particular action by the fluid. Examples of treatment fluids include, but are not limited to, drilling fluids, spacer fluids, workover fluids, cement compositions, and stimulation fluids.

During drilling operations, a wellbore is formed using a drill bit. A drill string can be used to aid the drill bit in drilling through a subterranean formation to form the wellbore. The drill string can include a drilling pipe. A treatment fluid adapted for this purpose is referred to as a drilling fluid or drilling mud. The wellbore defines a wellbore wall that is the exposed portion of the subterranean formation where the wellbore was formed. The drilling fluid may be circulated downwardly through the drilling pipe and back up the annulus between the wellbore wall and the outside of the drilling pipe.

After a wellbore is formed, it may be desirable to perform a cementing operation. A treatment fluid called a spacer fluid can be introduced into the wellbore after the drilling fluid and before the cement composition. The spacer fluid can flush residual drilling fluid that may remain in parts of the wellbore or on the face of the subterranean formation to help ensure better bonding of the cement composition to the interface. Other types of oil or gas operations, for example, completion or workover operations can also be performed with a treatment fluid.

The wellbore wall and near-wellbore region of the subterranean formation can include permeable areas. Examples of permeable areas include cracks, natural fissures, fractures, vugs, interconnected pores, or induced fractures. Cracks, fissures, and fractures can generally be characterized as having a length greater than its diameter. Vugs and holes can be characterized as being any cavity having a variety of shapes and sizes. Porosity refers to the number of individual pores within an area of the subterranean formation. Permeability and all grammatical variations thereof, in this context, refers to the amount of interconnectivity between the individual pores that allows fluid to migrate or move between the interconnected pores. Permeable areas in the wall of the wellbore and near-wellbore region can vary and have dimensions ranging from less than 0.1 micrometers and as large as 50 micrometers or larger. As used herein, a “permeable area” means any area where fluid can flow into the subterranean formation via a wellbore and can include-without limitation-cracks, fissures, fractures, cavities, and interconnected pores.

Some of the base fluid or filtrate of a treatment fluid can undesirably flow into the subterranean formation via the permeable areas instead of remaining in the wellbore and being circulated back up to the wellhead. This is known as fluid loss. In order to overcome the problems associated with fluid loss, a fluid loss control additive can be used. As the treatment fluid is placed into the well, the fluid loss control additive can eliminate or lessen the amount of liquid base fluid or filtrate entering the subterranean formation.

Fluid loss control additives can form a filtercake on the wall of the wellbore to reduce or stop fluid loss. A filtercake is the residue deposited on a permeable medium when a slurry, such as a drilling fluid, is forced against the medium under pressure. The filtrate is the liquid that passes through the medium, leaving the cake on the medium. In filtercake deposition, the slurry, that commonly includes materials including water, a gelling agent, calcium carbonate, weighting agents, and/or polymers, is introduced into the open-hole wellbore. The fluid flows into a desired portion of the well. The ingredients in the fluid form the filtercake. The filtercake can be used to bind fines, such as sand, together, and prevent fluid loss into the subterranean formation.

Other types of fluid loss control additives can include insoluble particulates and an additive. The insoluble particulates can enter the permeable areas and bridge upon each other to pack into the permeable areas, and the additive can bind the insoluble particulates consolidate into a relatively impermeable mass and form a filtercake.

Synthetic substances can be used as a fluid loss control additive. However, environmental regulations can limit which ingredients can be used in oil or gas operations. Moreover, synthetic substances can be more expensive compared to other substances. Thus, there is a need for new fluid loss control additives that can be used to treat fluid loss that are more environmentally friendly and comply with environmental regulations.

It has been discovered that an invert emulsion treatment fluid including a biodegradable fluid loss control additive can be used during wellbore operations. The fluid loss control additive can be less expensive than other polymeric or synthetic fluid loss control additives.

Inherent biodegradability refers to tests, which allow prolonged exposure of the test substance to microorganisms. As used herein, a material with a biodegradation rate of >20% is regarded as “inherently primary biodegradable.” A material with a biodegradation rate of >70% is regarded as “inherently ultimate biodegradable.” A material can be considered “biodegradable” if the material is either regarded as inherently primary biodegradable or inherently ultimate biodegradable. As used herein, the “inherent biodegradability” of a substance is tested in accordance with OECD guidelines, using the 302 B-1992 Zahn-Wellens test as follows. The test substance, mineral nutrients, and a relatively large amount of activated sludge in aqueous medium is agitated and aerated at 20° C. to 25° C. in the dark or in diffuse light for up to 28 days. A blank control, containing activated sludge and mineral nutrients but no test substance, is run in parallel. The biodegradation process is monitored by determination of DOC (or COD(2)) in filtered samples taken at daily or other time intervals. The ratio of eliminated DOC (or COD), corrected for the blank, after each time interval, to the initial DOC value is expressed as the percentage biodegradation at the sampling time. The percentage biodegradation is plotted against time to give the biodegradation curve.

If any laboratory test (e.g., rheology or fluid loss) requires the step of mixing, then the drilling fluid is mixed according to the following procedures. A known volume (in units of scaled barrels) of the base fluid is added to a mixing container and the container is then placed on a mixer base. The motor of the base is then turned on and maintained at 11,200 to 11,800 revolutions per minute (rpm). Any of the following ingredients are then added to the base fluid to form a drilling fluid and mixed for at least 5 minutes before adding the next ingredient, wherein the ingredients are added in order of the first ingredient to last ingredient as follows: an emulsifier; a viscosifier; a filtration control agent; an aqueous liquid; then optionally a shale stabilizer additive; a weighting agent; and a pH buffer. The ingredients can be added at a stated concentration of weight by volume of the drilling fluid, for example, in units of pounds per barrel of the drilling fluid. It is to be understood that any mixing is performed at ambient temperature and pressure—about 71° F. (22° C.) and about 1 atm (0.1 MPa).

It is also to be understood that if any laboratory test (e.g., rheology or fluid loss) requires the test be performed at a specified temperature and possibly a specified pressure, then the temperature and pressure of the drilling fluid is ramped up to the specified temperature and pressure after being mixed at ambient temperature and pressure. For example, the drilling fluid can be mixed at 71° F. (22° C.) and 1 atm (0.1 MPa) and then placed into the testing apparatus and the temperature of the drilling fluid can be ramped up to the specified temperature. As used herein, the rate of ramping up the temperature is in the range of about 3° F./min to about 5° F./min (about 1.67° C./min to about 2.78° C./min) to simulate actual wellbore conditions. After the drilling fluid is ramped up to the specified temperature and possibly pressure, the drilling fluid is maintained at that temperature and pressure for the duration of the testing.

A drilling fluid should exhibit good rheological properties. Rheology is a measure of how a material deforms and flows. As used herein, the “rheology” of a drilling fluid is measured according to ANSI/API 13B-2 section 6.3, Recommended Practice for Field Testing of Oil-based Drilling Fluids as follows. The drilling fluid is mixed. The drilling fluid is placed into the test cell of a rotational viscometer, such as a FANN® Model 35 or 45 viscometer, fitted with a Bob and Sleeve attachment and a F1 spring number. The drilling fluid is tested at the specified temperature and ambient pressure, about 1 atm (0.1 MPa). Rheology readings are taken at multiple revolutions per minute “rpm,” for example, at 3, 6, 100, 200, 300, and 600.

As used herein, the “plastic viscosity” of a drilling fluid is obtained from the Bingham-Plastic rheological model and calculated as the difference between the 600 rpm and 300 rpm dial readings from the rheology testing, expressed in units of centipoise (cP).

Rheology measurements can be performed before hot rolling (BHR) or after hot rolling (AHR). As used herein, “hot rolling” is performed according to ANSI/API 13I section 26.8, Recommended Practice for Laboratory Testing of Drilling Fluids as follows. Samples of the drilling fluid are hot-rolled for 16 hours at 80° C. (176° F.) or other specified temperature, in a preheated hot-rolling oven. Pressurization of the hot-roll cell with nitrogen can be used. After 16 h of hot rolling, switch off the oven heat and open the oven door. Roll the samples during the cooling period for at least 30 min prior to removal. Subsequently, cool in ambient air for an additional 30 min. Then cool the cell to ambient temperature by partially immersing the cell in water.

The yield point (“YP”) is defined as the value obtained from the Bingham-Plastic rheological model when extrapolated to a shear rate of zero. As used herein, the “yield point” of a drilling fluid is calculated as the difference between the plastic viscosity and the 300-rpm dial reading, expressed in units of pounds per 100 square feet (lb/100 ft²). To convert the units to pascals (Pa), the difference is multiplied by 0.48. Similarly, the yield stress or Tau zero is the stress that must be applied to a material to make it begin to flow (or yield) and may commonly be calculated from rheometer readings measured at rates of 3, 6, 100, 200, 300 and 600 rpm. The extrapolation in this case may be performed by applying a least-squares fit or curve fit to the Herchel-Bulkley rheological model.

A substance can develop gel strength. As used herein, the “10 s gel strength” of a drilling fluid is measured according to ANSI/API 13B-2, Fourth edition, section 6.3, Recommended Practice for Field Testing Oil-Based Drilling Fluids as follows. After the rheology testing of the drilling fluid is performed, the drilling fluid is allowed to sit in the test cell for 10 seconds(s). Slowly and steadily turn the hand-wheel in the appropriate direction to produce a positive dial reading. Record the maximum reading as the initial gel strength. For instruments having a 3 r/min speed, the maximum reading attained after starting rotation at 3 r/min is the initial gel strength. Record the initial gel strength (10-second gel) in lb/100 ft². As used herein, the “10 min gel strength” is measured as follows. After the 10 s gel strength test has been performed, restir the drilling fluid sample at 600 r/min for 10 s and then allow the drilling fluid to stand undisturbed for 10 min. Repeat the measurements as in the 10 s gel strength and report the maximum reading as the 10 min gel strength in lb/100 ft². To convert the dial reading from pounds per 100 square feet to Pa: 1 Pa=0.48 lb/100 ft².

Another desirable property of a drilling fluid is electrical stability. As used herein, the “electrical stability” of a drilling fluid is tested according to ANSI/API 13B-2, Fourth edition, section 10.4, Recommended Practice for Field Testing of Oil-Based Drilling Fluids procedure at a specified temperature and pressure differential as follows. Mix the drilling fluid. Screen the drilling fluid sample through a Marsh funnel. Place the drilling fluid sample in a viscometer cup maintained at 50° C.±2° C. (120° F.±5° F.). Record the drilling fluid temperature. Clean the electrode probe body of an electrical stability (ES) meter thoroughly by wiping with a clean paper towel. Pass the towel through the electrode gap a few times. Swirl the electrode probe in the base oil used to formulate the drilling fluid. If the base oil is not available, another oil or a mild solvent, such as isopropanol, is acceptable. Clean and dry the electrode probe as before. Hand-stir the 50° C. (120° F.) drilling fluid sample with the electrode probe for approximately 10 s to ensure that the composition and temperature are uniform. Position the electrode probe so that it does not touch the bottom or sides of the container and be sure that the electrode surfaces are completely covered by the sample. Begin the voltage ramp test. Follow the procedure described in the ES meter operating manual. Do not move the electrode probe during the voltage ramp test. At the conclusion of the ramp test, note the ES value displayed on the readout device. Repeat the procedure with the same drilling fluid sample. The two ES values should not differ by more than 5%. If they differ by more than 5%, check the meter or electrode probe for malfunction. Record the average of the two ES measurements.

Another desirable property of a drilling fluid is low fluid loss. As used herein, the “high-temperature/high pressure fluid loss (HTHP fluid loss)” of a drilling fluid is tested according to ANSI/API 13B-2, Fourth edition, section 7.2, Recommended Practice for Field Testing of Oil-based Drilling Fluids procedure at a specified temperature and pressure differential as follows. The drilling fluid is mixed. The drilling fluid is stirred for 5 min using a multi-mixer. The drilling fluid is poured into the filter cell. The testing apparatus is assembled with a filter paper inserted into the apparatus. The specified pressure differential is set. When the sample reaches the selected test temperature, the lower valve stem is opened, and the pressure is immediately increased on the upper regulator to 500 psi higher than the backpressure. A timer is started. The testing is performed for 30 min. Filtrate is collected from the test cell in a graduated cylinder and corrected to the filter area. Fluid loss is measured in milliliters (mL) of fluid collected in 30 min. HT/HP filter cells usually have half the standard filter area, so the volume collected is multiplied by 2 to convert to the total volume collected.

The thickness of the filtercake formed can also be measured to evaluate the performance of additives. As used herein, “filtercake thickness” is measured as follows. The solids deposited on the filter paper during the standard 30-minute HTHP fluid loss test are measured with a ruler in 1/32-inch increments. The filtercake thickness is reported in units of millimeters (mm).

A treatment fluid can be an invert emulsion and include a bridging agent of insoluble particles and a fluid loss control additive of a biodegradable surfactant, wherein the surfactant has a hydrophobic-lipophilic balance less than or equal to 5, wherein the treatment fluid has a high-pressure, high-temperature fluid loss less than 5 milliliters per 30 minutes after hot rolling at a testing temperature of 250° F. (121.1° C.) and a pressure differential of 500 pounds force per square inch (psi) (3.45 megapascals “MPa”).

Methods of treating a subterranean formation can include introducing the treatment fluid into the subterranean formation and causing or allowing the fluid loss control additive to reduce loss of the base fluid into permeable areas of the subterranean formation.

It is to be understood that the discussion of any of the embodiments regarding the treatment fluid or any ingredient in the treatment fluid is intended to apply to all of the method and composition embodiments without the need to repeat the various embodiments throughout. Any reference to the unit “gallons” means U.S. gallons.

The treatment fluid can be used in a variety of oil or gas operations. The treatment fluid can be, for example, a drilling fluid, a spacer fluid, a workover fluid, a stimulation fluid, or a cement composition.

The treatment fluid can be an invert emulsion. The treatment fluid includes a base fluid. The base fluid can include dissolved materials or undissolved solids. The base fluid can include a hydrocarbon liquid as the continuous phase of the invert emulsion. The hydrocarbon liquid can be selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a fractional distillate of crude oil is diesel oil. The saturated hydrocarbon can be an alkane or paraffin. The paraffin can be an isoalkane (isoparaffin), a linear alkane (paraffin), or a cyclic alkane (cycloparaffin). The unsaturated hydrocarbon can be an alkene, alkyne, or aromatic. The alkene can be an isoalkene, linear alkene, or cyclic alkene. The linear alkene can be a linear alpha olefin or an internal olefin.

The treatment fluid can include water. The water can be the dispersed or discontinuous phase of the invert emulsion. The water can be selected from the group consisting of freshwater, seawater, brine, and any combination thereof in any proportion. The treatment fluid can include a water-soluble salt. The water-soluble salt can be selected from the group consisting of sodium chloride, calcium chloride, calcium bromide, potassium chloride, potassium bromide, magnesium chloride, sodium formate, potassium formate, cesium formate, zinc bromide, and any combination thereof. The treatment fluid can have a desired water phase salinity (WPS). Water phase salinity is a factor showing the activity level of salt in an oil-based drilling fluid (invert emulsion fluid) and can indicate the concentration of dissolved salt in the brine droplets within the fluid. The treatment fluid can have a water phase salinity in the range of about 100,000 to about 400,000 parts per million (ppm).

The treatment fluid can also have a desired oil-to-water ratio. The treatment fluid can have an oil-to-water ratio (OWR) in the range of 60:40 to 90:10. The oil-to-water ratio can be selected such that the oil (hydrocarbon liquid) of the base fluid is in the largest proportion and forms the continuous phase of the invert emulsion treatment fluid.

The treatment fluid includes a bridging agent of insoluble particles. The insoluble particles can include, for example: ground coal; petroleum coke; sized calcium carbonate; barite; ilmenite; hematite; manganese tetroxide; asphaltene; perlite; cellophane; cellulose; ground tire material; ground oyster shell; vitrified shale; a plastic material; paper fiber; wood; cement; hardened foamed cement; glass; foamed glass; sand; bauxite; a ceramic material; a polymeric material (such as ethylene vinyl acetate); a polytetrafluoroethylene material; ground nut shells, for example walnut, almond, or pecan; ground seed shells, for example sunflower seed shells; ground fruit pits; clay; silica; alumina; fumed carbon; carbon black; recycled carbon black; graphite; mica; titanium oxide; meta-silicate; calcium silicate; calcium carbonate; kaolin; talc; zirconia; boron; fly ash; a hollow glass microsphere; any composite particle thereof; and any combination thereof. The insoluble particles can have a mean particle size measured at a largest dimension in a range of 5 to 1,000 micrometers. Desired percentages of the insoluble particles can also be included in different sized ranges, for example, 50% of the insoluble particles can have a mean particle size of 50 micrometers and the other 50% can have a mean particle size of 75 micrometers. The bridging agent can be in a concentration in a range of 10 to 100 pounds per barrel (ppb) (38.7 to 387 kilograms per cubic meter “kg/m³”) of the treatment fluid.

The treatment fluid also includes a fluid loss control additive. The fluid loss control additive is a biodegradable surfactant. The fluid loss control additive can meet environmental regulations. By way of example, regulatory framework for North Sea waters requires that fluid components must meet or exceed toxicity and biodegradability ratings (among other criteria) for permitted use in oil and gas drilling and completion operations. Additives that can be used would be designated as green or yellow color bands according to the OSPAR Commission. Additives not meeting these standards are rated red and flagged for future substitution, meaning they are scrutinized during the permitting process. Products with such a substitution warning are subject to removal once viable replacements are identified with more favorable environmental characteristics. Approved additives can be used for drilling with cuttings discharge in some areas if the waste meets the limits for retained non-aqueous fluid. In the North Sea example, there is no discharge of the cuttings because it is offshore drilling; however, the regulations are still applied in view of the risks for minor contamination into the North Sea waters. Accordingly, the fluid loss control additive in the treatment fluid can be used to replace other fluid loss control additives that are rated red and flagged for future substitution, such as synthetic fluid loss control additives.

A surfactant is an amphiphilic molecule comprising a hydrophobic tail group and a hydrophilic head group. The hydrophilic head can be charged. A cationic surfactant includes a positively charged head. An anionic surfactant includes a negatively charged head. A zwitterionic surfactant includes both a positively- and negatively charged head. A surfactant with no charge is called a non-ionic surfactant. A surfactant with a charged hydrophilic head can detrimentally affect the treatment fluid's properties. By way of example, a cationic, anionic, or zwitterionic surfactant having a charged head increases the hydrophobic-lipophilic balance (HLB) of the surfactant, which can lead to coalescence or destabilization of emulsion droplets, which further leads to water wetting of fluid solids and eventually may cause phase separation or emulsion destabilization. According to any of the embodiments, the biodegradable surfactant is a non-ionic surfactant. According to any of the embodiments, the biodegradable surfactant is not a cationic, anionic, or zwitterionic surfactant.

A surfactant can lower the interfacial tension between two liquids or between a solid and a liquid. As such, the biodegradable surfactant can be used to reduce the surface tension between the aqueous and hydrocarbon phases of the fluid, which can enhance emulsion stability as well as the ability to adsorb on the bridging agent in order to consolidate the particles together.

The biodegradable surfactant also has a hydrophobic-lipophilic balance (HLB) less than or equal to 5. The hydrophilic-lipophilic balance (HLB) of a surfactant is a measure of its degree of hydrophilicity or lipophilicity, determined by calculating percentages of molecular weights for the hydrophilic and lipophilic portions of the surfactant molecule. One formula that can be used to calculate HLB is listed below as equation 1.

$$HLB = 20 * Mh / M \qquad Eq . 1$$

where Mh is the molecular mass of the hydrophilic portion of the emulsifier; and M is the molecular mass of the surfactant as a whole.

The HLB scale ranges from 0 to 20. The HLB of a surfactant can be used to determine whether an emulsion forms as a water-in-oil or an oil-in-water emulsion. A surfactant with an HLB greater than about 6 is generally not suitable for use in water-in-oil invert emulsions. As the HLB increases, the surfactant's performance in an invert emulsion decreases. One example of decreased performance is the surfactant can adsorb onto the solid bridging agent particles and/or the subterranean formation and make the solids water wet. Wettability means the preference of a surface to be in contact with one liquid or gas rather than another. Accordingly, “oil-wet” means the preference of a surface to be in contact with an oil phase rather than a water phase, and “water-wet” means the preference of a surface to be in contact with a water phase rather than an oil phase. Accordingly, if the biodegradable surfactant being used in the invert emulsion treatment fluid changes the wettability of the solids to water-wet instead of oil-wet, then the base fluid and insoluble particles of the bridging agent may not effectively enter the permeable areas and consolidate together to provide sufficient fluid loss control. Additionally with a change to water-wet, the water in oil phases can coalesce and begin separating, which is undesirable because the fluid solids will separate out, which causes sagging of the solids. Such decreased performance can necessitate the use of additional surfactants or emulsifiers, which not only increases the cost of the treatment fluid, but also may need to include surfactants that are not biodegradable or marked red or flagged for substitution.

The biodegradable surfactant can also have an HLB less than or equal to 4. The biodegradable surfactant can have an HLB in a range from 0.5 to 5 or 0.5 to 4. The biodegradable surfactant can also be selected such that the surfactant has an HLB in a range that does not change the wettability of solids from oil-wet to water-wet, maintains the water properly dispersed throughout the continuous oil phase, and/or allows the insoluble particles of the bridging agent to enter the permeable areas of the subterranean formation and consolidate. The biodegradable surfactant can also be selected such that the surfactant has an HLB in a range to provide a desired amount of fluid loss control, for example, such that the treatment fluid has a high-pressure, high-temperature fluid loss less than 5 milliliters per 30 minutes after hot rolling at a testing temperature of 250° F. (121.1° C.) and a pressure differential of 500 psi (3.45 MPa).

The biodegradable surfactant can be selected from members of sorbitan esters, also known as sorbitan fatty acid esters. Sorbitan esters are also referred to as SPAN® series of surfactants having different types based on structural modifications. Non-limiting examples of members of sorbitan esters include sorbitan laurate, sorbitan stearate, sorbitan oleate, sorbitan sesquioleate, and sorbitan trioleate.

The sorbitan ester as the biodegradable surfactant can be selected from structurally different compounds, for example by having different fatty acid groups (e.g., fatty acid groups selected from lauric acid, oleic acid, or stearic acid), having different carbon chain lengths (e.g., a chain length in a range of C₁₂ to C₂₀), or having different percentages or ratios of monoesters, diesters, triesters, and tetraesters. By way of example, SPAN® 60 contains predominately monoesters of stearic acid while SPAN® 80 contains predominantly monoesters of oleic acid and SPAN® 85 contains predominantly triesters of oleic acid. According to any of the embodiments, the sorbitan ester as the biodegradable surfactant includes predominantly monoesters, diesters, triesters, or tetraesters.

According to any of the embodiments, the biodegradable surfactant is sorbitan oleate. Sorbitan oleate is produced by esterification of one or more sorbitan hydroxyl groups with a fatty acid. The structural formula for sorbitan oleate is shown below.

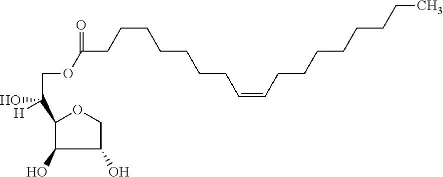 [SMILES: CCCCCCCC/C=C\CCCCCCCC(=O)OC[C@@H](O)[C@H]1OC[C@H](O)[C@H]1O]

The fluid loss control additive, biodegradable surfactant, can be used in a concentration in the range of 1 to 10 pounds per barrel (ppb) (3.9 to 38.7 kg/m³) of the treatment fluid. The concentration of the fluid loss control additive can also be selected such that the treatment fluid has a high-pressure, high-temperature fluid loss less than 5 milliliters per 30 minutes after hot rolling at a testing temperature of 250° F. (121.1° C.) and a pressure differential of 500 psi (3.45 MPa).

The bridging agent and the fluid loss control additive can be used to inhibit or prevent fluid loss from the wellbore into the formation via the permeable areas. It should be understood that while some of the base fluid or the filtrate may penetrate into the subterranean formation, the bridging agent and the fluid loss control additive should provide the desired fluid loss control.

There can be a multitude of permeable areas comprising the same or different types of voids, such as fractures, fissures, vugs, or interconnected pores. The dimensions of the permeable areas can be different. By way of example, a fracture may have a length that is greater than 50 micrometers; while pores may have dimensions around 1 micrometer. The fluid loss control additive may prevent or reduce fluid loss into any of the permeable areas regardless of the dimensions of the permeable areas.

According to any of the embodiments, the fluid loss control additive provides a desired fluid loss control. For example, a desired fluid loss control can be at least 60%, 70%, 80%, or 90% by volume of the invert emulsion fluid is not lost through the permeable areas of the subterranean formation. The treatment fluid has a high-pressure, high-temperature fluid loss less than 5 milliliters per 30 minutes (mL/30 min) after hot rolling at a testing temperature of 250° F. (121.1° C.) and a pressure differential of 500 psi (3.45 MPa). The treatment fluid can also have a high-pressure, high-temperature fluid loss less than 1 milliliters per 30 minutes (mL/30 min) after hot rolling at a testing temperature of 250° F. (121.1° C.) and a pressure differential of 500 psi (3.45 MPa). The treatment fluid can also have an HP/HT fluid loss less than 5 mL/30 min after hot rolling at a testing temperature of 300° F. (148.9° C.) or a testing temperature in a range of 93.3° C. to 176.7° C. (200° F. to 350° F.) and a pressure differential of 500 psi (3.45 MPa).

A test treatment fluid can be used to determine the predicted performance of whether a treatment fluid provides the desired fluid loss control. As used herein, a “test treatment fluid” means a test fluid consisting of identical ingredients and in the same concentration as the treatment fluid. As used herein, a “control test fluid” means a fluid consisting of identical ingredients except without the fluid loss control additive and in the same concentration as the test treatment fluid. Different test treatment fluids can also be tested, and the HT/HP fluid loss can be used to determine the efficiency and performance of the fluid loss control additive compared to a control or other fluid loss control additive that are not able to be used due to environmental regulations. Accordingly, the fluid loss can determine the performance of the biodegradable surfactant fluid loss control additive against a control and other fluid loss control additives that do not meet environmental regulations. In a best-case scenario, an exemplary fluid loss control additive (FLCA) could theoretically provide an HT/HP fluid loss value of zero, which indicates 100% effectiveness and performance. By contrast, a performance in the range of 0% to 35% would designate poor functioning materials, which are not suitable for industrial use. According to any of the embodiments, a test treatment fluid provides a high-pressure, high-temperature fluid loss less than 5 milliliters per 30 minutes after hot rolling at a testing temperature of 250° F. (121.1° C.) and a pressure differential of 500 psi (3.45 MPa) compared to a control test fluid that is identical to the test treatment fluid but does not include the fluid loss control additive. According to any of the embodiments, the test treatment fluid provides a HT/HP fluid loss that is less than or equal to that of a second test fluid, wherein the second test fluid includes a fluid loss control additive that is labeled as red and flagged for future substitution.

It is to be understood that while the treatment fluid can contain other ingredients, it is the fluid loss control additive that is primarily or wholly responsible for providing the requisite fluid loss control. For example, a “test treatment fluid” that is identical to the treatment fluid can have the desirable fluid loss control. Therefore, it is not necessary for the treatment fluid to include other additives to achieve the desired fluid loss control. It is also to be understood that any discussion related to a “test treatment fluid” is included for purposes of demonstrating that while the treatment fluid being introduced into a wellbore may contain other ingredients, it is the fluid loss control additive that provides the desired fluid loss control. Therefore, while it may not be possible to perform a test in a wellbore for the specific treatment fluid being introduced, one can formulate a test treatment fluid to be tested in a laboratory to identify if the ingredients and concentration of the ingredients will provide the desired fluid loss control.

The treatment fluid can also contain other ingredients. The other ingredients can be: ingredients that chemically react to form a cementitious substance to help form a filtercake, for example, diatomaceous earth, lime, and silica; a viscosifier; a shale stabilizer; a weighting agent; a pH buffer; an emulsifier; an emulsifier activator (e.g., lime); a dispersion aid; a corrosion inhibitor; an emulsion thinner; an emulsion thickener; a gelling agent; a filter cake breaker; a foaming agent; a gas; a breaker; a biocide; a chelating agent; a scale inhibitor; a gas hydrate inhibitor; a mutual solvent; an oxidizer; a friction reducer; a clay stabilizing agent; an oxygen scavenger; and any combination thereof.

The treatment fluid can have desirable properties that can affect the pumpability and suspending capability of the fluid. The treatment fluid can have a plastic viscosity in the range of 10 to 90 centipoise (cP), or 10 to 40 cP before hot rolling or after hot rolling at a temperature of 176° F. (80° C.). The plastic viscosity can also be in a range such that the treatment fluid is pumpable. The treatment fluid can have a yield point in the range of 2 to 40 pounds per 100 sq. ft. (lb/100 ft²) (0.96 to 19.2 Pa) before hot rolling or after hot rolling at a temperature of 176° F. (80° C.). The treatment fluid can also have a yield point in a range such that the bridging agent insoluble particles are suspended in the base fluid. The treatment fluid can have a 10 sec gel strength in the range of 1 to 30 lb/100 ft² (0.48 to 14.4 Pa) and a 10 min gel strength in the range of 1 to 60 lb/100 ft² (0.48 to 24 Pa) before hot rolling or after hot rolling at a temperature of 176° F. (80° C.). The treatment fluid can have a desired electrical stability in the range of 200 to 1,700 volts (V) before hot rolling or after hot rolling at a temperature of 176° F. (80° C.).

The methods can include mixing the base fluid, the water, the bridging agent, and fluid loss control additive together. According to any of the embodiments, the methods include the step of introducing the treatment fluid into a subterranean formation. The subterranean formation can be penetrated by a wellbore. The well can be an oil, gas, or water production well, a geothermal well, or an injection well. The well can be an on-shore well or an off-shore well. The well includes the wellbore. The subterranean formation can be part of a reservoir or adjacent to a reservoir. The treatment fluid can be a drilling fluid, and the step of introducing the treatment fluid can be for the purpose of drilling the wellbore. The drilling fluid can be in a pumpable state before and during introduction into the subterranean formation. The well can include an annulus. The step of introducing the treatment fluid can include introducing the treatment fluid into a portion of the annulus. The treatment fluid can also be a spacer fluid, a workover fluid, a stimulation fluid, or a cement composition. The methods can also include introducing one or more additional fluids before and/or after the step of introducing the treatment fluid.

An embodiment of the present disclosure is a treatment fluid comprising: a continuous phase comprising a hydrocarbon liquid; a discontinuous phase comprising water; a bridging agent of insoluble particles; and a fluid loss control additive, wherein the fluid loss control additive is a biodegradable surfactant having a hydrophobic-lipophilic balance less than or equal to 5, wherein the treatment fluid has a high-pressure, high-temperature fluid loss less than 5 milliliters per 30 minutes after hot rolling at a testing temperature of 250° F. (121.1° C.). Optionally, the hydrocarbon liquid is selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Optionally, the water is selected from the group consisting of freshwater, seawater, brine, and any combination thereof in any proportion. Optionally, the discontinuous phase further comprises a water-soluble salt selected from the group consisting of sodium chloride, calcium chloride, calcium bromide, potassium chloride, potassium bromide, magnesium chloride, sodium formate, potassium formate, cesium formate, zinc bromide, and any combination thereof. Optionally, the treatment fluid is an invert emulsion having an oil-to-water ratio in the range of 60:40 to 90:10. Optionally, the insoluble particles are selected from the group consisting of ground coal; petroleum coke; sized calcium carbonate; barite; ilmenite; hematite; manganese tetroxide; asphaltene; perlite; cellophane; cellulose; ground tire material; ground oyster shell; vitrified shale; a plastic material; paper fiber; wood; cement; hardened foamed cement; glass; foamed glass; sand; bauxite; a ceramic material; a polymeric material; a polytetrafluoroethylene material; ground nut shells, for example walnut, almond, or pecan; ground seed shells, for example sunflower seed shells; ground fruit pits; clay; silica; alumina; fumed carbon; carbon black; recycled carbon black; graphite; mica; titanium oxide; meta-silicate; calcium silicate; calcium carbonate; kaolin; talc; zirconia; boron; fly ash; a hollow glass microsphere; any composite particle thereof; and any combination thereof in any proportion. Optionally, the insoluble particles have a mean particle size measured at a largest dimension in a range of 5 to 1,000 micrometers. Optionally, the bridging agent is in a concentration in a range of 10 to 100 pounds per barrel (38.7 to 387 kilograms per cubic meter) of the treatment fluid. Optionally, the biodegradable surfactant is a non-ionic surfactant. Optionally, the biodegradable surfactant has a hydrophobic-lipophilic balance in a range from 0.5 to 5. Optionally, the biodegradable surfactant is selected from a sorbitan ester. Optionally, the sorbitan ester is sorbitan laurate, sorbitan stearate, sorbitan oleate, sorbitan sesquioleate, or sorbitan trioleate. Optionally, the sorbitan ester comprises a fatty acid group selected from lauric acid, oleic acid, or stearic acid; has a carbon chain length in a range of C₁₂ to C₂₀; and monoesters, diesters, triesters, tetraesters, or combinations thereof. Optionally, the sorbitan ester is sorbitan oleate. Optionally, the fluid loss control additive is in a concentration in a range of 1 to 10 pounds per barrel (3.9 to 38.7 kilograms per cubic meter) of the treatment fluid. Optionally, the treatment fluid has a plastic viscosity in a range of 10 to 90 centipoise and a yield point in a range of 2 to 40 pounds per 100 sq. ft. (0.96 to 19.2 Pa) before hot rolling or after hot rolling at a temperature of 176° F. (80° C.). Optionally, the treatment fluid has a high-pressure, high-temperature fluid loss less than 1 milliliters per 30 minutes after hot rolling at a testing temperature of 250° F. (121.1° C.) and pressure differential of 500 psi (3.45 megapascals).

Another embodiment of the present disclosure is a method of treating a portion of a subterranean formation comprising: introducing a treatment fluid into a wellbore that penetrates the subterranean formation, the treatment fluid comprising: a continuous phase comprising a hydrocarbon liquid; a discontinuous phase comprising water and a water-soluble salt; a bridging agent of insoluble particles; and a fluid loss control additive, wherein the fluid loss control additive is a biodegradable surfactant having a hydrophobic-lipophilic balance less than or equal to 5, wherein the treatment fluid has a high-pressure, high-temperature fluid loss less than 5 milliliters per 30 minutes after hot rolling at a testing temperature of 250° F. (121.1° C.); and causing or allowing the fluid loss control additive to reduce fluid loss of the continuous phase of the treatment fluid into the subterranean formation. Optionally, the hydrocarbon liquid is selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Optionally, the water is selected from the group consisting of freshwater, seawater, brine, and any combination thereof in any proportion. Optionally, the discontinuous phase further comprises a water-soluble salt selected from the group consisting of sodium chloride, calcium chloride, calcium bromide, potassium chloride, potassium bromide, magnesium chloride, sodium formate, potassium formate, cesium formate, zinc bromide, and any combination thereof. Optionally, the treatment fluid is an invert emulsion having an oil-to-water ratio in the range of 60:40 to 90:10. Optionally, the insoluble particles are selected from the group consisting of ground coal; petroleum coke; sized calcium carbonate; barite; ilmenite; hematite; manganese tetroxide; asphaltene; perlite; cellophane; cellulose; ground tire material; ground oyster shell; vitrified shale; a plastic material; paper fiber; wood; cement; hardened foamed cement; glass; foamed glass; sand; bauxite; a ceramic material; a polymeric material; a polytetrafluoroethylene material; ground nut shells, for example walnut, almond, or pecan; ground seed shells, for example sunflower seed shells; ground fruit pits; clay; silica; alumina; fumed carbon; carbon black; recycled carbon black; graphite; mica; titanium oxide; meta-silicate; calcium silicate; calcium carbonate; kaolin; talc; zirconia; boron; fly ash; a hollow glass microsphere; any composite particle thereof; and any combination thereof in any proportion. Optionally, the insoluble particles have a mean particle size measured at a largest dimension in a range of 5 to 1,000 micrometers. Optionally, the bridging agent is in a concentration in a range of 10 to 100 pounds per barrel (38.7 to 387 kilograms per cubic meter) of the treatment fluid. Optionally, the biodegradable surfactant is a non-ionic surfactant. Optionally, the biodegradable surfactant has a hydrophobic-lipophilic balance in a range from 0.5 to 5. Optionally, the biodegradable surfactant is selected from a sorbitan ester. Optionally, the sorbitan ester is sorbitan laurate, sorbitan stearate, sorbitan oleate, sorbitan sesquioleate, or sorbitan trioleate. Optionally, the sorbitan ester comprises a fatty acid group selected from lauric acid, oleic acid, or stearic acid; has a carbon chain length in a range of C₁₂ to C₂₀; and monoesters, diesters, triesters, tetraesters, or combinations thereof. Optionally, the sorbitan ester is sorbitan oleate. Optionally, the fluid loss control additive is in a concentration in a range of 1 to 10 pounds per barrel (3.9 to 38.7 kilograms per cubic meter) of the treatment fluid. Optionally, the treatment fluid has a plastic viscosity in a range of 10 to 90 centipoise and a yield point in a range of 2 to 40 pounds per 100 sq. ft. (0.96 to 19.2 Pa) before hot rolling or after hot rolling at a temperature of 176° F. (80° C.). Optionally, the treatment fluid has a high-pressure, high-temperature fluid loss less than 1 milliliters per 30 minutes after hot rolling at a testing temperature of 250° F. (121.1° C.) and pressure differential of 500 psi (3.45 megapascals).

### EXAMPLES

To facilitate a better understanding of the various embodiments, the following examples are given.

Different invert emulsion test fluids were prepared to test the performance and effectiveness of a biodegradable surfactant as the fluid loss control additive against a control fluid (blank) and a polymeric fluid loss control additive that is marked red or on the list of additives that should be substituted. The ingredients are listed in order of addition in concentration of pounds per barrel (ppb) with the mixing time after each addition denoted in the time column. Drill solids were added to more accurately simulate a drilling fluid. Bridging agents 1 and 2 were calcium carbonate insoluble particles having different mean particle sizes of 5 micrometers and 400 micrometers, respectively. HTHP fluid loss was performed with a pressure differential of 500 pounds force per square inch (psi).

The test fluids for Table 1 had a density of 10.43 pounds per gallon (lb/gal) (1.25 kilograms per liter “kg/L”), an oil-to-water ratio (OWR) of 75:25, and a water phase salinity of 150,000 parts per million (ppm). The control (blank) fluid did not include a fluid loss control additive (“FLCA”). A synthetic polymeric fluid loss control additive of a tall oil derivative in solvents (“FLCA #1”) that is considered to be a good performing fluid loss control additive was tested against a biodegradable surfactant of sorbitan oleate (“FLCA #2”). The base oil for Table 1 was a hydrocarbon oil with low aromatic content.

TABLE 1
(Mud Weight 10.43 ppg, OWR 75:25, WPS 150,000 ppm)

| Products (in order | Time | | | | | | |
|---|---|---|---|---|---|---|---|
| of addition), ppb | (min) | Blank | | FLCA#1 | | FLCA #2 | |
| Base oil | — | 169.86 | | 169.54 | | 169.54 | |
| Emulsifier | 2 | 8.75 | | 8.75 | | 8.75 | |
| Lime | 2 | 4.00 | | 4.00 | | 4.00 | |
| Water | 5 | 71 | ml | 71.4 | ml | 71.4 | ml |
| CaCl₂ | | 18.25 | g | 18.30 | g | 18.30 | g |
| Rheology modifier | 5 | 3.85 | | 3.85 | | 3.85 | |
| FLCA | 5 | — | | 5 | | 5 | |
| Suspension agent | 5 | 4.55 | | 4.55 | | 4.55 | |
| Drill solids | 5 | 17.54 | | 17.54 | | 17.54 | |
| Barite | 5 | 87.61 | | 79.25 | | 79.25 | |
| Bridging agent 1 | 5 | 45.61 | | 45.61 | | 45.61 | |
| Bridging agent 2 | | 7.02 | | 7.02 | | 7.02 | |
| Mixer Type | | Multimixer | | Multimixer | | Multimixer | |
| Mixer Speed, rpm | | 11,600 | | 11,600 | | 11,600 | |
| Mix Volume | | 2 | bbl | 2 | bbl | 2 | bbl |

| | |
|---|---|
| Aging conditions | Hot roll 16 hours at 176° F. (80° C.) |

| Fluid rheology at | Blank | | FLCA#1 | | FLCA #2 | |
|---|---|---|---|---|---|---|
| 122° F. (50° C.) | BHR | AHR | BHR | AHR | BHR | AHR |
| 600 rpm | 109 | 41 | 68 | 39 | 65 | 45 |
| 300 rpm | 82 | 26 | 51 | 24 | 48 | 31 |
| 200 rpm | 70 | 20 | 43 | 18 | 40 | 25 |
| 100 rpm | 58 | 14 | 34 | 12 | 31 | 19 |
| 6 rpm | 56 | 7 | 28 | 5 | 30 | 11 |
| 3 rpm | 55 | 6 | 27 | 4 | 27 | 10 |
| Plastic Viscosity, cP | 27 | 15 | 17 | 15 | 17 | 14 |
| Yield Point, lb/100 ft² | 55 | 11 | 34 | 9 | 31 | 17 |
| Tau 0, lb/100 ft² | 59.35 | 6.11 | 27.75 | 4.02 | 28.01 | 9.97 |
| 10-sec gel, lb/100 ft² | 46 | 10 | 35 | 7 | 28 | 17 |
| 10-min gel, lb/100 ft² | 51 | 11 | 41 | 20 | 34 | 28 |
| Electrical Stability, Volts | 464 | 431 | 498 | 421 | 697 | 782 |
| HPHT Fluid loss @ 250° F. | | 8.4 | | 4 | | 0.4 |
| (121.1° C.), mL/30 min | | | | | | |
| Filtercake thickness, mm | | 5 | | 2 | | 2 |
| HPHT Fluid loss @ 300° F. | | 12.4 | | 6.8 | | 4.0 |
| (148.9° C.), mL/30 min | | | | | | |
| Filtercake thickness, mm | | 7 | | 6 | | 3 |

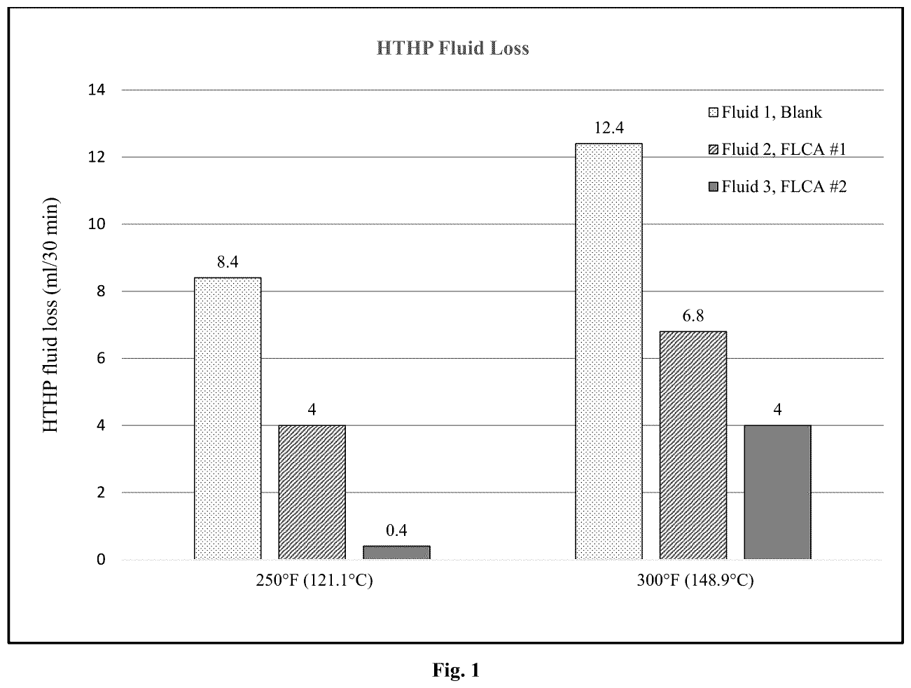

As can be seen in Table 1 and FIG. 1, the sorbitan oleate (“FLCA #2”) performed better than the synthetic fluid loss control additive (“FLCA #1) after hot rolling, with a HTHP fluid loss over 2 times less than the synthetic and over 3 times less than the blank. Moreover, because the synthetic FLCA may not be used due to environmental regulations, this shows that the biodegradable surfactant can be used to replace the synthetic FLCA in oil and gas operations. Moreover, the test fluid containing sorbitan oleate as the biodegradable surfactant exhibited excellent properties, such as the rheological profile and other properties, that indicates the pumpability of the fluid as well as the suspending capability of the fluid would be very suitable for use in wellbore operations.

Other test fluids containing different ingredients, different concentrations, and a higher hot rolling temperature were prepared to evaluate the effectiveness of sorbitan oleate as a fluid loss control agent. The test fluids for Table 2 had a density of 12 lb/gal (1.44 kg/L), an oil-to-water ratio (OWR) of 75:25, and a water phase salinity of 250,000 parts per million (ppm). The control (blank) fluid did not include a fluid loss control additive (“FLCA”). A synthetic polymeric fluid loss control additive of a liquid suspension of a butadiene-based polymer (“FLCA #1”) that is considered to be a good performing fluid loss control additive was tested against a biodegradable surfactant of sorbitan oleate (“FLCA #2”). The base oil for Table 2 was a linear alkane hydrocarbon oil.

TABLE 2
(Mud Weight 14 ppg, OWR 75:25, WPS 230,000 ppm)

| Products (in order of | Time | | | |
|---|---|---|---|---|
| addition), ppb | (min) | FLCA#1 | FLCA #2 | Blank |
| Base oil | ′— | 159 | 159 | 159 |
| Emulsifier | 2 | 12 | 12 | 12 |
| Lime | 2 | 3 | 3 | 3 |
| FLCA | 5 | 3 | 3 | — |
| Water | 5 | 65.6 | 65.6 | 65.6 |
| CaCl₂ | | 22.8 | 22.8 | 22.8 |
| Organoclay-based viscosifier | 5 | 8 | 8 | 8 |
| Bridging agent | 5 | 10 | 10 | 10 |
| Rheology modifier | 5 | 2 | 2 | 2 |
| Weighting agent | 5 | 218 | 218 | 218 |
| Mixer Type | | Multi- | Multi- | Multi- |
| | | mixer | mixer | mixer |
| Mixer Speed, rpm | | 11,600 | 11,600 | 11,600 |
| Mix Volume | | 2 bbl | 2 bbl | 2 bbl |

| Aging conditions | | Hot roll 16 hours at 300° F. | | | | |
|---|---|---|---|---|---|---|
| | | (148.9° C.) | | | | |
| Fluid rheology at 120° F. | FLCA#1 | | FLCA #2 | | Blank | |
| (48.9° C.) | BHR | AHR | BHR | AHR | BHR | AHR |
| 600 rpm | 73 | 65 | 59 | 43 | 54 | 49 |
| 300 rpm | 47 | 40 | 35 | 25 | 33 | 29 |
| 200 rpm | 36 | 31 | 26 | 18 | 25 | 21 |
| 100 rpm | 25 | 21 | 18 | 12 | 18 | 15 |
| 6 rpm | 15 | 8 | 12 | 5 | 13 | 6 |
| 3 rpm | 14 | 7 | 11 | 4 | 12 | 5 |
| 10 s gel, lb/100 ft² | 22 | 9 | 20 | 7 | 18 | 9 |
| 10 m gel, lb/100 ft² | 68 | 17 | 54 | 10 | 56 | 14 |
| PV, cP | 26 | 25 | 24 | 18 | 21 | 20 |
| YP, 1b/100 ft² | 21 | 15 | 11 | 7 | 12 | 9 |
| HPHT fluid loss at 300° F., | | 2.4 | | 2.4 | | 6.0 |
| ml/30 min | | | | | | |
| ES at 120° F., volts | 965 | 361 | 845 | 261 | 922 | 418 |

As can be seen in Table 2, even when the concentrations were decreased of the sorbitan oleate (“FLCA #2”) (3 ppb versus 5 ppb in Table 1) and the bridging agent (10 ppb versus almost 53 ppb in Table 1), the sorbitan oleate performed equally well compared to the synthetic fluid loss control additive (“FLCA #1) after hot rolling, with a HTHP fluid equal to the synthetic and about 3 times less than the blank. Moreover, because the synthetic FLCA may not be used due to environmental regulations, this shows that the biodegradable surfactant can be used to replace the synthetic FLCA in oil and gas operations. Moreover, the test fluid containing sorbitan oleate as the biodegradable surfactant exhibited excellent properties, such as the rheological profile and other properties, that indicates the concentrations of the biodegradable surfactant as a fluid loss control agent and the bridging agent can be adjusted yet still exhibit excellent performance.

Therefore, the various embodiments are well adapted to attain the ends and advantages mentioned as well as those that are inherent therein. The particular embodiments disclosed above are illustrative only, as the various embodiments may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more ingredients, etc., as the case may be, and do not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

What is claimed is:

1. A treatment fluid comprising:
a continuous phase comprising a hydrocarbon liquid;
a discontinuous phase comprising water;
a bridging agent of insoluble particles; and
a fluid loss control additive, wherein the fluid loss control additive is a biodegradable surfactant having a hydrophobic-lipophilic balance less than or equal to 5,
wherein the treatment fluid has a high-pressure, high-temperature fluid loss less than 5 milliliters per 30 minutes after hot rolling at a testing temperature of 250° F. (121.1° C.).

2. The treatment fluid according to claim 1, wherein the hydrocarbon liquid is selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof.

3. The treatment fluid according to claim 1, wherein the water is selected from the group consisting of freshwater, seawater, brine, and any combination thereof in any proportion.

4. The treatment fluid according to claim 1, wherein the discontinuous phase further comprises a water-soluble salt selected from the group consisting of sodium chloride, calcium chloride, calcium bromide, potassium chloride, potassium bromide, magnesium chloride, sodium formate, potassium formate, cesium formate, zinc bromide, and any combination thereof.

5. The treatment fluid according to claim 1, wherein the treatment fluid is an invert emulsion having an oil-to-water ratio in the range of 60:40 to 90:10.

6. The treatment fluid according to claim 1, wherein the insoluble particles are selected from the group consisting of ground coal; petroleum coke; sized calcium carbonate; barite; ilmenite; hematite; manganese tetroxide; asphaltene; perlite; cellophane; cellulose; ground tire material; ground oyster shell; vitrified shale; a plastic material; paper fiber; wood; cement; hardened foamed cement; glass; foamed glass; sand; bauxite; a ceramic material; a polymeric material; a polytetrafluoroethylene material; ground nut shells, for example walnut, almond, or pecan; ground seed shells, for example sunflower seed shells; ground fruit pits; clay; silica; alumina; fumed carbon; carbon black; recycled carbon black; graphite; mica; titanium oxide; meta-silicate; calcium silicate; calcium carbonate; kaolin; talc; zirconia; boron; fly ash; a hollow glass microsphere; any composite particle thereof; and any combination thereof in any proportion.

7. The treatment fluid according to claim 1, wherein the insoluble particles have a mean particle size measured at a largest dimension in a range of 5 to 1,000 micrometers.

8. The treatment fluid according to claim 1, wherein the bridging agent is in a concentration in a range of 10 to 100 pounds per barrel (38.7 to 387 kilograms per cubic meter) of the treatment fluid.

9. The treatment fluid according to claim 1, wherein the biodegradable surfactant is a non-ionic surfactant.

10. The treatment fluid according to claim 1, wherein the biodegradable surfactant has a hydrophobic-lipophilic balance in a range from 0.5 to 5.

11. The treatment fluid according to claim 1, wherein the biodegradable surfactant is selected from a sorbitan ester.

12. The treatment fluid according to claim 11, wherein the sorbitan ester is sorbitan laurate, sorbitan stearate, sorbitan oleate, sorbitan sesquioleate, or sorbitan trioleate.

13. The treatment fluid according to claim 11, wherein the sorbitan ester comprises a fatty acid group selected from lauric acid, oleic acid, or stearic acid; has a carbon chain length in a range of C₁₂ to C₂₀; and monoesters, diesters, triesters, tetraesters, or combinations thereof.

14. The treatment fluid according to claim 11, wherein the sorbitan ester is sorbitan oleate.

15. The treatment fluid according to claim 1, wherein the fluid loss control additive is in a concentration in a range of 1 to 10 pounds per barrel (3.9 to 38.7 kilograms per cubic meter) of the treatment fluid.

16. The treatment fluid according to claim 1, wherein the treatment fluid has a plastic viscosity in a range of 10 to 90 centipoise and a yield point in a range of 2 to 40 pounds per 100 sq. ft. (0.96 to 19.2 Pa) before hot rolling or after hot rolling at a temperature of 176° F. (80° C.).

17. The treatment fluid according to claim 1, wherein the treatment fluid has a high-pressure, high-temperature fluid loss less than 1 milliliters per 30 minutes after hot rolling at a testing temperature of 250° F. (121.1° C.) and pressure differential of 500 psi (3.45 megapascals).

18. A method of treating a portion of a subterranean formation comprising:
introducing a treatment fluid into a wellbore that penetrates the subterranean formation, the treatment fluid comprising:
a continuous phase comprising a hydrocarbon liquid;
a discontinuous phase comprising water and a water-soluble salt;
a bridging agent of insoluble particles; and
a fluid loss control additive, wherein the fluid loss control additive is a biodegradable surfactant having a hydrophobic-lipophilic balance less than or equal to 5,
wherein the treatment fluid has a high-pressure, high-temperature fluid loss less than 5 milliliters per 30 minutes after hot rolling at a testing temperature of 250° F. (121.1° C.); and
causing or allowing the fluid loss control additive to reduce fluid loss of the continuous phase of the treatment fluid into the subterranean formation.

19. The method according to claim 18, wherein the biodegradable surfactant is sorbitan laurate, sorbitan stearate, sorbitan oleate, sorbitan sesquioleate, or sorbitan trioleate.

20. The method according to claim 18, wherein the biodegradable surfactant has a hydrophobic-lipophilic balance in a range from 0.5 to 5.
